(19) United States
(12) Patent Application Publication
(10) Pub. No.: US 2014/0111417 A1
(43) Pub. Date: Apr. 24, 2014

(54) FLEXIBLE DISPLAY APPARATUS, APPARATUS TO CAPTURE IMAGE USING THE SAME, AND METHOD OF EDITING IMAGE

(71) Applicant: Samsung Electronics Co., Ltd, Suwon-si (KR)

(72) Inventor: Woo-ram SON, Seoul (KR)

(73) Assignee: Samsung Electronics Co., Ltd, Suwon-si (KR)

(21) Appl. No.: 13/896,535

(22) Filed: May 17, 2013

(30) Foreign Application Priority Data
Oct. 22, 2012 (KR) 10-2012-0117555

(51) Int. Cl. G06F 3/03

(52) U.S. Cl. CPC G06F 3/03
USPC 345/156

(57) ABSTRACT

The present general inventive concept discloses a flexible display apparatus, image capturing apparatus using the same, and an image editing method. The flexible display apparatus according to the present general inventive concept includes a receiver which receives an image, a displayer of which a changing of shape is possible, a sensor for sensing a changing of shape of the displayer, and a controller which converts an image displayed on the displayer according to the changing of shape of the displayer, when a changing of shape of the displayer is sensed.

### CROSS-REFERENCE TO RELATED APPLICATIONS

This application claims the benefit of priority under 35 U.S.C. §119 from Korean Patent Application No. No. 2012-0117555, filed in the Korean Intellectual Property Office on Oct. 22, 2012, the disclosure of which is incorporated herein by reference in its entirety.

### BACKGROUND OF THE INVENTION

1. Field of the Invention

Methods and apparatuses consistent with the exemplary embodiments relate to a flexible display apparatus, apparatus to capture an image using the same, and a method of editing an image, and more particularly, to a flexible display apparatus which can be manipulated and change display when an image is displayed, an apparatus for capturing an image using the same, and a method of editing an image thereof.

2. Description of the Related Art

An apparatus for capturing an image, such as a camera, is an electronic apparatus which may capture a subject and store the captured image as digital data. In a conventional camera, distortion may occur due to lens effects during a process of capturing the subject. Therefore, a conventional camera corrects lens distortions which exist in a captured image by an image processor, afterwards.

In a conventional distortion correction method, a captured image may be corrected according to a distortion factor predetermined at the time of manufacturing the camera. However, a type and characteristic of lens may differ according to the environment where the subject is captured and the state of the lens. For example, various kinds of distortions, such as barrel distortion, pincushion distortion, and mustache distortion, etc., may occur. However, a conventional camera performs correction on a captured image by applying a uniform distortion factor to several predefined distortion shapes, and thus it is not possible to perform a precise distortion correction.

In addition, in a case where a user manually edits an image, when a conventional apparatus for capturing an image uses a fisheye effect according to a smart filter technology, it processes the captured image afterwards such that the image appears as if it were captured by fisheye lens to perform an image conversion.

Furthermore, it is possible to convert the captured image into various shapes using PC software. However, such a method of editing an image using PC software could only perform predetermined effects, and a user could not control distortion. In addition, according to a conventional image editing method, it is only possible to input a distortion factor numerically and it is only possible for the user to change the image on a two-dimensional screen, and thus there is a limitation that it is not possible to exert various image editing effects.

### SUMMARY OF THE INVENTION

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a flexible display apparatus may include a receiver which receives an image; a displayer of which a changing of shape is possible; a sensor for sensing a changing of shape of the displayer; and a controller which converts an image displayed on the displayer according to the changing of shape of the displayer, when a changing of shape of the displayer is sensed.

The controller may analyze the changed shape of the displayer to calculate a converted coordinate system, and convert the image based on the converted coordinate system.

The controller may analyze the changed shape of the displayer to obtain a three-dimensional coordinate system, and map the obtained three-dimensional coordinate value into a two-dimensional coordinate value to calculate the changed coordinate system.

The flexible display apparatus may further include a storage unit which stores an image, and the controller may convert the image displayed on the displayer and store the converted image in the storage unit, when a changing of shape of the displayer is sensed.

The displayer may change its shape such as by a bending and rolling in an unspecified direction based on a specific point.

The foregoing and/or other features and utilities of the present general inventive concept may also be achieved by providing an image capturing apparatus that includes an image photographer to photograph an image; a displayer which may change its shape and displays the photographed image; a sensor for sensing a changing of shape of the displayer; and a controller which converts the image displayed on the displayer according to the changing of shape of the displayer, when a changing of shape of the displayer is sensed.

The controller may control the image photographer to control a focus, contrast, sharpness, and white balance etc. of the image converted according to the changing of shape of the displayer.

The controller may analyze the changed shape of the displayer to calculate a converted coordinate system, and convert the image based on the converted coordinate system.

The controller may analyze the changed shape of the displayer to obtain a three-dimensional coordinate value, and maps the obtained three-dimensional coordinate value into a two-dimensional coordinate value to calculate the changed coordinate system.

The image capturing apparatus may further include a storage unit which stores an image, and the controller may convert the image displayed on the displayer according to the changing of shape of the displayer, when a changing of shape of the displayer is sensed.

The displayer may change its shape such as by a bending and rolling in an unspecified direction based on a specific point.

The foregoing and/or other features and utilities of the present general inventive concept may also be achieved by providing an image editing method using a flexible displayer comprising receiving an input of an image; sensing a changing of shape of the displayer; and converting an image displayed on the displayer according to the changing of shape of the displayer, when a changing of shape of the displayer is sensed.

The converting of the image may include analyzing the changed shape of the displayer to calculate a converted coordinate system; and converting the image based on the converted coordinate system.

The converting of the image may further include analyzing the shape of the displayer to obtain a three-dimensional coordinate value; and mapping the obtained three-dimensional coordinate value into a two-dimensional coordinate value to calculate the converted coordinate system.

The image editing method may further include converting the image displayed on the displayer and storing the converted image, when a changing of shape of the displayer is sensed.

The displayer may change its shape such as by a bending and rolling in an unspecified direction based on a specific point.

The foregoing and/or other features and utilities of the present general inventive concept may also be achieved by providing an image editing method of an image capturing apparatus provided with a flexible displayer comprising photographing an image; displaying the photographed image; sensing a changing of shape of the displayer; and converting the image according to the changing of shape of the displayer, when a changing of shape of the displayer is sensed.

The image editing method may further include adjusting a focus, contrast, sharpness, and white balance etc. of the image converted according to the changing of shape of the displayer.

The converting of the image may include analyzing the changed shape of the displayer to calculate a converted coordinate system; and converting the image based on the converted coordinate system.

The converting of the image may further include analyzing the shape of the displayer to obtain a three-dimensional coordinate value; and mapping the obtained three-dimensional coordinate value into a two-dimensional coordinate value to calculate the converted coordinate system.

The image editing method may further include storing the converted image.

The displayer may change its shape such as by a bending and rolling in an unspecified direction based on a specific point.

The foregoing and/or other features and utilities of the present general inventive concept may also be achieved by providing a flexible display device, comprising a substrate having a structure that can be physically manipulated by a user to change shape; a display panel mounted on the substrate including a plurality of pixels; a driver mounted on the substrate configured to provide a driving voltage to the plurality of pixels; a bend sensor mounted on the substrate to detect when the substrate is bent; a tilt sensor mounted on the substrate to detect when the substrate is tilted; and a controller configured to adjust the display of an image on the device based on detections of manipulation from the tilt sensor and one or more bend sensors.

The tilt sensor may a geomagnetic sensor and an acceleration sensor.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a block diagram illustrating a configuration of a flexible display apparatus according to an exemplary embodiment of the present general inventive concept;

FIG. 2 is a view illustrating an example of a configuration of a displayer having flexible characteristics;

FIGS. 3 to 5 are views illustrating an example of a method of sensing a bending state in a flexible display apparatus according to an exemplary embodiment of the present general inventive concept;

FIGS. 6 to 8 are views illustrating an example of a method of sensing bending using a bend sensor in a flexible display apparatus according to an exemplary embodiment of the present general inventive concept;

FIGS. 9 and 10 are views illustrating another example of a method of sensing bending using a bend sensor in a flexible display apparatus according to an exemplary embodiment of the present general inventive concept;

FIG. 11 is a view illustrating an example of a method of editing an image displayed on a flexible display apparatus according to an exemplary embodiment of the present general inventive concept;

FIG. 12 is a view illustrating another example of a method of editing an image displayed on a flexible display apparatus according to an exemplary embodiment of the present general inventive concept;

FIG. 13 is a view illustrating another example of a method of editing an image displayed on a flexible display apparatus according to an exemplary embodiment of the present general inventive concept;

FIG. 14 is a block diagram for illustrating a configuration of a camera where a flexible display apparatus is mounted according to an exemplary embodiment of the present general inventive concept;

FIG. 15 is a block diagram illustrating a configuration of an apparatus for capturing an image provided with a flexible display apparatus according to another exemplary embodiment of the present general inventive concept;

FIG. 16 is a view illustrating various examples of a method of changing a displayer of an apparatus for capturing an image according to another exemplary embodiment of the present general inventive concept;

FIG. 17 is a flowchart illustrating an image editing method using a flexible display apparatus according to another exemplary embodiment of the present general inventive concept;

FIG. 18 is a flowchart illustrating an image editing method using an apparatus for capturing an image provided with a flexible displayer according to another exemplary embodiment of the present general inventive concept; and

FIG. 19 is a view illustrating a result of editing an image displayed on a flexible displayer.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

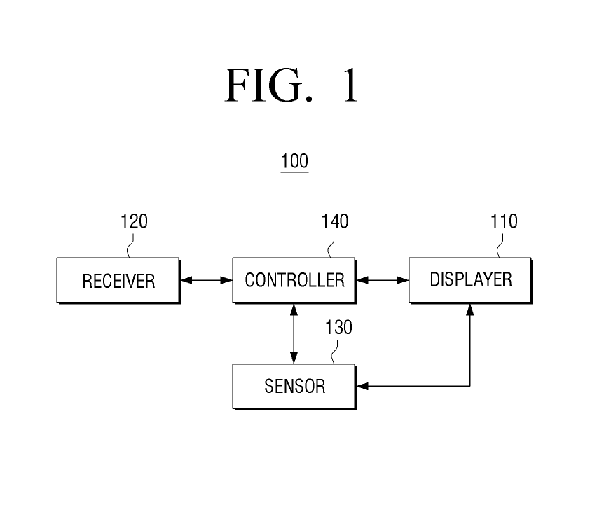

FIG. 1 is a block diagram illustrating a configuration of a flexible display apparatus according to an exemplary embodiment of the present general inventive concept. According to FIG. 1, the flexible display apparatus 100 includes a displayer 110, receiver 120, sensor 130, and controller 140.

The displayer 110 displays a contents screen which includes images, video, and texts. The flexible display apparatus 100 which includes the displayer 110 has bending characteristics. Accordingly, the displayer 110 must be made of bendable structure and material. Detailed configuration of the displayer 110 will be explained hereinafter.

The receiver 120 receives data regarding a screen displayed on the displayer 110. The receiver 120 may receive data from outside, and may function as a communication interface which may be connected to an external electronic apparatus which stores various contents data.

The sensor 130 senses a change of shape of the displayer 110. That is, since the displayer 110 is made of bendable structure and material, when external force is applied to the flexible displayer 110, a change of shape such as bending, rolling, or a combination thereof may occur according to the type of the external force.

The sensor 130 may sense whether or not a surface has changed by means of a bend sensor which may be provided in one side surface or both side surfaces of the displayer 110. That is, when a displacement of the bend sensor occurs in response to a change of shape of the displayer 110, the sensor 130 may sense whether or not the displayer 110 has changed, the type of the change, the degree of the change, and the changed shape, etc.

In a state where an image is displayed on the displayer 110, when a changing of shape of the displayer 110 is sensed through the sensor 130, the controller 140 analyzes shape information of the displayer 110 of which the shape has changed. That is, the controller 140 collects information on the change of shape of the displayer 110, and converts a previous coordinate system of the displayer 110 into a new coordinate system based on the collected information on the change of shape. The controller 140 converts the image by mapping the previous coordinate value of the image displayed on the displayer 110 into a new coordinate system.

When a bending of the displayer 110 is sensed in a state where an image is not displayed on the displayer 110, the controller 140 does not analyze the shape of the bent displayer 110. When an image is displayed on the bent displayer 110, the controller 140 analyzes the shape of the bent displayer 110, converts the previous pixel coordinate value according to a new coordinate value based on the analyzed shape, and converts the displayed image.

Hereinafter is detailed explanation of a configuration of the displayer 110 and a bending sensing method thereof.

<Example of a Structure of a Flexible Displayer and Bending Sensing Method Thereof>

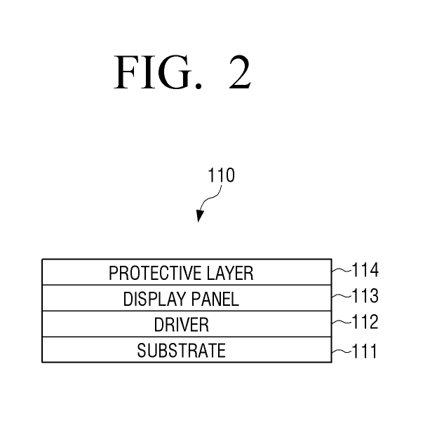

FIG. 2 is a view illustrating a basic structure of a displayer which configures a flexible display apparatus according to an exemplary embodiment of the present general inventive concept. According to FIG. 2, the displayer 110 includes a substrate 111, driver 112, display panel 113 and protective layer 114.

The flexible display apparatus 100 refers to an apparatus which may bend, curve, be folded, or rolled while maintaining display characteristics of a conventional flat panel display apparatus. Therefore, the flexible display apparatus must be manufactured on a flexible substrate.

More specifically, the substrate 111 may be embodied by a plastic substrate (for example, high molecule film) which may be changed by external force.

A plastic substrate has a structure where barrier coating is processed on both surfaces on a base film. The base film may be embodied by any of various types of resins, such as PI (Polyimide), PC (Polycarbonite), PET (Polyethyleneterephtalate), PES (Polyethersulfone), PEN (Polythylenenaphthalate), or FRP (Fiber Reinforced Plastic), etc. In addition, the barrier coating is performed in the base material on surfaces opposite to each other, and an organic or nonorganic film may be used to maintain flexibility.

In addition, for the substrate 111, material having flexible characteristics such as thin glass or metal foil etc. may be used besides plastic substrate.

The driver 112 plays a function of driving the display panel 113. More specifically, the driver 112 approves a driving voltage to a plurality of pixels which configure the display panel 113, and may be embodied, for example, as a-si TFT, LTPS (low temperature poly silicon) TFT, OTFT (organic TFT), etc. The driver 112 may be embodied in various forms according to the embodiment form of the display panel 113. For example, the display panel 113 may be made of organic luminant consisting of a plurality of pixel cells and an electrode layer which covers both surfaces of the organic luminant. In this case, the driver 112 may include a plurality of transistors corresponding to each pixel cell of the display panel 113. The controller 140 approves an electrical signal to a gate of each transistor, and illuminates pixel cells connected to the transistor. Accordingly, an image may be displayed.

Otherwise, the display panel 113 may be embodied as, for example, EL, EPD (electrophoretic display), ECD (electrochromic display), LCD (liquid crystal display), AMLCD, or PDP (Plasma display Panel), besides organic light emitting diodes. However, in the case of an LCD, since it cannot emit light itself, an additional backlight is necessary. In the case of an LCD where a backlight is not used, surrounding light is used. Therefore, in order to use the LCD display panel 113 without backlight, conditions such as outdoor environment where there is much light must be satisfied.

The protective layer 114 has a function of protecting the display panel 113. For example, material such as ZrO, CeO2, ThO2 etc. may be used in the protective layer 114. The protective layer 114 may be made in a transparent film format and cover an entire surface of the display panel 113.

Furthermore, unlike as illustrated in FIG. 2, the displayer 110 may be embodied as electronic paper. Electronic paper is a display where general characteristics of ink are applied to paper, but the difference is that it uses reflected light, unlike a flat panel display. Meanwhile, electronic paper may change a picture or letter using electrophoresis using a twist ball or capsule.

In a case where the displayer 110 comprises transparent material, it may be embodied as a display apparatus which may be bent and has transparent characteristics. For example, the substrate 111 may be embodied as polymer material such as plastic having transparent characteristics, and in a case where the driver 112 is embodied as a transparent transistor and the display panel 113 is embodied as a transparent organic light emitting layer and transparent electrode, it may have transparency.

A transparent transistor refers to a transistor made by replacing nontransparent silicon of an existing thin film transistor with transparent material such as zinc oxide or titanium oxide, etc. In addition, new material such as ITO (indium tin oxide) or grapheme may be used in a transparent electrode. Herein, grapheme refers to material where carbon atoms are connected to one another forming a hive shape flat panel structure, having transparent characteristics. Otherwise, transparent organic light emitting layers may also be embodied by various types of material.

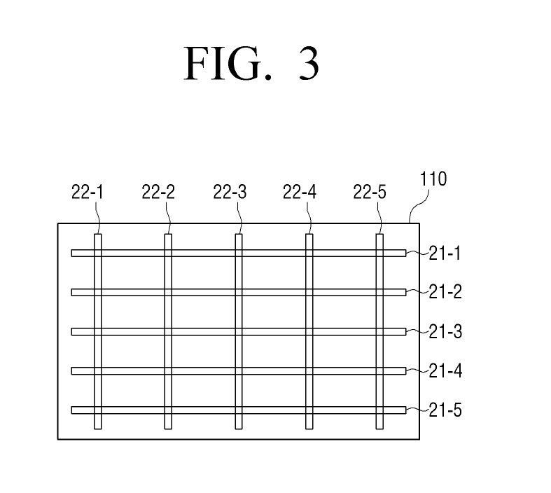

FIGS. 3 to 5 are views illustrating an example of a method of sensing a changing of shape of the displayer, that is a bending, according to an exemplary embodiment of the present general inventive concept.

The displayer 110 may be bent by external force, changing its shape. Bending may include cases of a normal bending, folding, and rolling. A normal bending refers to a state where the flexible display apparatus is bent.

Folding refers to a state where the displayer is folded. Herein, folding and normal bending may be distinguished by a bending degree. For example, when a bending is made of or above a certain bending angle, it is defined as a folded state, whereas when a bending is made below that bending angle, it is defined as a normal bending.

Rolling refers to a state where the flexible display apparatus is rolled up. Rolling may also be determined based on the bending angle. For example, a state where a bending of or above a certain bending angle is sensed in a certain area may be defined as a rolling. On the other hand, a state where a bending below a certain bending angle is sensed in an area relatively smaller than that of a rolling may be defined as a folding. The aforementioned normal bending, folding, rolling, etc., may be determined based on a radius of curvature besides the bending angle.

In addition, a state where a cross section of the rolled displayer 110 substantially has a shape close to a circle or oval may be defined as a rolling, regardless of the radius of curvature.

However, the aforementioned definition regarding various examples of shape change is merely an exemplary embodiment, and thus definition may be made differently according to a type, size, weight, characteristic, etc., of the displayer 110. For example, if a bending is possible such that different areas of the surface of the displayer 110 may touch each other, the folding may be defined as a state where the areas of the apparatus surface contact each other while bending. Similarly, rolling may be defined as a state where the front and back surfaces of the displayer 110 may contact each other due to bending.

For convenience of explanation, in the present specification, the aforementioned and other various types of bending are to be hereinafter referred to collectively as bending.

The flexible display apparatus 100 may sense a bending in various methods.

For example, the sensor 130 may include a bend sensor placed on one surface, such as front surface or back surface of the displayer 110, or a bend sensor placed on both surfaces of the displayer 110. The controller 140 may detect a bending sensed in the bend sensor of the sensor 130.

Herein, the bend sensor refers to a sensor which may be bent itself, and which has a characteristic where a resistance value differs according to a degree of bending. The bend sensor may be embodied in various shapes such as an optical bending sensor, pressure sensor, strain gauge, etc.

The sensor 130 may use a size of voltage approved to the bend sensor or a size of current flowing in the bend sensor to sense a resistance value of the bend sensor, and sense a bending state at a location of the corresponding bend sensor according to the size of that resistance value.

FIG. 3 illustrates a state where a bend sensor is mounted within a front surface of the displayer 110, but this is merely an example. The bend sensor may be mounted within a back surface of the displayer 110, or within both surfaces thereof. In addition, a shape, number and arrangement location of the bend sensor may also change in various ways. For example, one bend sensor or a plurality of bend sensors may be combined to the displayer 110. Herein, one bend sensor may be one that senses one bending data, but it may also be one that has a plurality of sensing channels which sense a plurality of bending data.

FIG. 3 illustrates an example in which a plurality of bar shape bend sensors are placed in traverse and longitudinal directions to form a lattice shape.

According to FIG. 3, the bend sensor includes bend sensors 21-1 to 21-5 placed in a first direction and bend sensors 22-1 to 22-5 placed in a second direction vertical to the first direction. Each bend sensor may be distanced from each other by a certain distance.

FIG. 3 illustrates an example where five bend sensors 21-1 to 21-5, 22-1 to 22-5 are placed in each of the traverse and longitudinal directions, but this is merely an example, and thus the number of the bend sensors may differ according to the size of the flexible display apparatus, etc. As such, the reason that the bend sensors are placed in traverse and longitudinal directions is for sensing the bending made in the displayer 110, and thus in a case where it is necessary to sense bending of only a partial area or where only a partial area has flexible characteristics, the bend sensors may be placed in the corresponding portion only.

Each bend sensor 21-1 to 21-5 and 22-1 to 22-5 may be embodied as, for example, an electric resistance sensor which uses electric resistance or a micro optical fiber sensor which uses a distortion of an optical fiber. Hereinafter, explanation will be based on a case where the bend sensor is embodied as an electric resistance sensor for convenience of explanation.

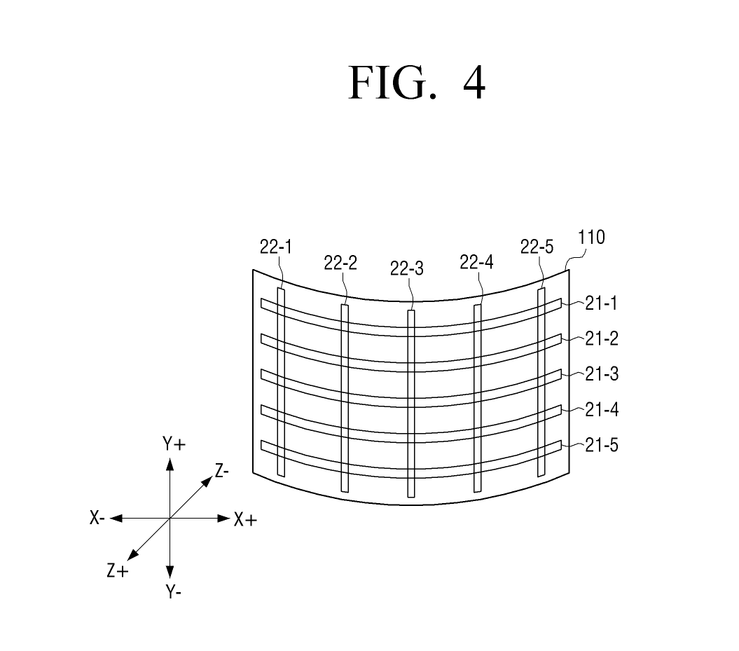

More specifically, in a case where the displayer 110 is bent such that a central area of the displayer 110 protrudes in an Z-direction as external force is applied in an X-axis direction in both left and right edges of the displayer 110 as illustrated in FIG. 4, external force by the bending is applied to the bend sensors 21-1 to 21-5 placed in a traverse direction. Accordingly, changes occur in each bend sensor 21-1 to 21-5 placed in the traverse direction, and the respective resistance value differs according to the size of the changes.

The sensor 130 may sense a change of an output value from each bend sensor 21-1 to 21-5 to sense that a bending has occurred in the X-axis direction in the displayer 110. FIG. 4 illustrates a state wherein the central area is bent in the Z-axis direction of the surface of the displayer 110, but a bending may also be sensed based on changes of the output value of bend sensors 21-1 to 21-5 of traverse direction when the central area is bent in an opposite surface direction along the Z-axis based on the display surface.

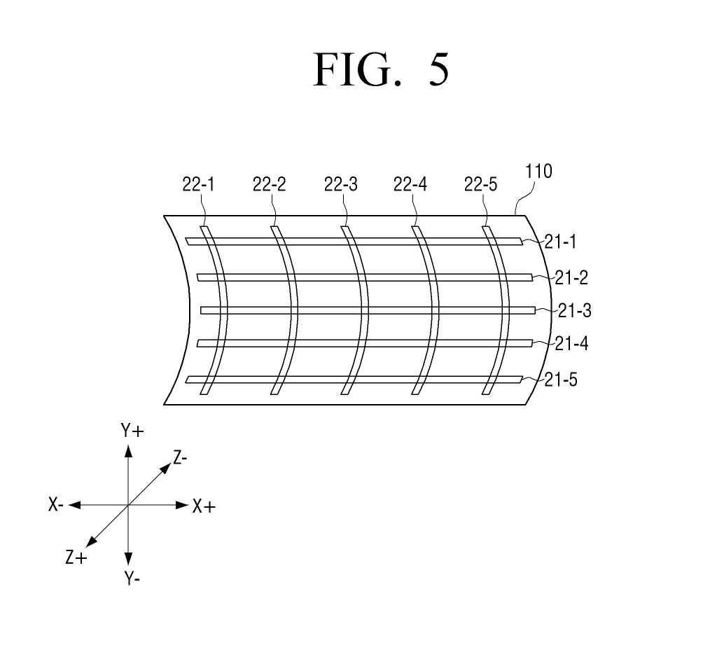

In addition, as illustrated in FIG. 5, when the shape of the displayer 110 is bent by an external force applied in the Y-axis direction based on the upper and lower edges, the external force is applied to the bend sensors 22-1 to 22-5 placed in the Y-axis direction. The change of shape occurs in the bend sensors 22-1 to 22-5 by the external force, and the resistance value differs according to the size of change. The sensor 130 may sense the change of shape in the longitudinal direction based on the output value of the bend sensors 22-1 to 22-5 placed in the Y-axis direction. FIG. 5 illustrates a bending in a Z− direction, but a bending in a Z+ direction may also be sensed using the bend sensors 22-1 to 22-5 placed in a longitudinal direction.

Meanwhile, in a case of a change of shape in a diagonal direction, tension is applied to bend sensors placed in both the traverse and longitudinal directions, and thus it is possible to sense the change of shape in the diagonal direction based on the output values of the bend sensors placed in the traverse and longitudinal directions.

Hereinafter a detailed explanation is provided of a method of sensing each change of shape such as a normal bending, folding, rolling, etc., using the bend sensor.

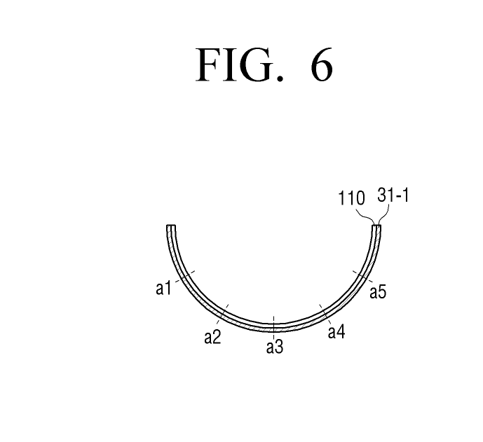

FIGS. 6 to 8 are views illustrating a method of sensing a bending in the displayer using a bend sensor, according to an exemplary embodiment of the present general inventive concept.

FIG. 6 illustrates a cross-sectional view of the displayer 110 when the displayer 110 is bent.

When the flexible display apparatus 100 is bent, a bend sensor placed on one surface or both surfaces of the flexible display apparatus are also bent together, having a resistance value corresponding to the intensity of the tension applied thereto, and a corresponding output value is output.

For example, when the flexible display apparatus 100 is bent as in FIG. 6, the bend sensor 31-1 placed on a back surface of the flexible display apparatus is also bent, outputting a resistance value according to a size of the tension applied.

In such a case, the intensity of the tension increases in proportion to the degree of bending. For example, when a bending is made as in FIG. 6, the degree of bending of the central area becomes the greatest. Therefore, the biggest tension is applied to the bend sensor 31-1 at point a3, and accordingly, there the bend sensor 31-1 has the biggest resistance value. On the other hand, the degree of bending weakens as it goes towards the outward direction. Accordingly, the bend sensor 31-1 has a smaller resistance value than at point a3 as it goes to points a2, a1 or points a4, a5, compared to point a3.

When the resistance value output from the bend sensor has a maximum value at a certain point and becomes smaller as it goes towards both directions, the area where the maximum value is detected may be determined as the area where the biggest bending is made. In addition, the sensor 130 may determine that the area where the resistance value does not change is a flat area where a bending is not made, and determine that an area where the resistance value is changed by or above a certain degree is an area where a bending is made even if by a small degree.

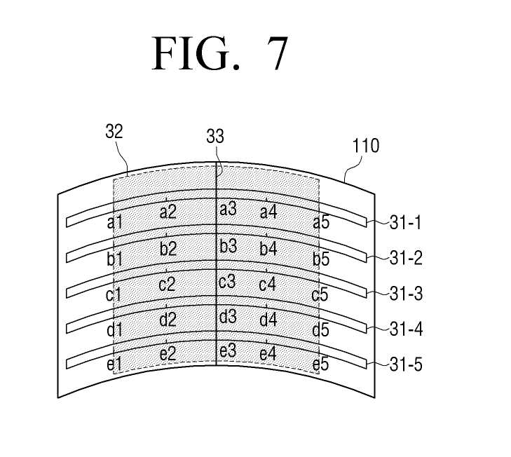

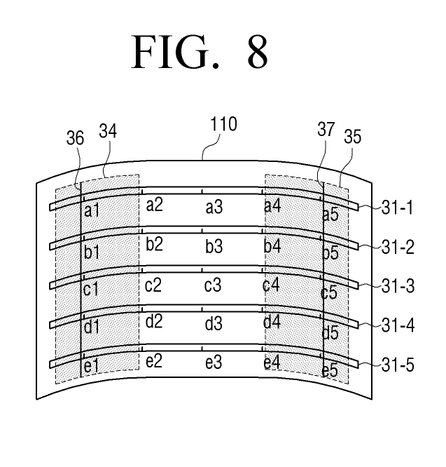

FIGS. 7 and 8 are views illustrating a method of defining a bending area according to an exemplary embodiment of the present general inventive concept. FIGS. 7 and 8 illustrate cases wherein the flexible display apparatus is bent in a traverse direction based on the front surface, and thus bend sensors placed in a longitudinal direction are omitted for convenience of explanation. In addition, for convenience of explanation, the reference numerals of bend sensors are different in each figure, but in practice, the bend sensors as in the structure of FIG. 3 may be used.

A bending area refers to an area bent as the flexible display apparatus is bent. Since a bend sensor is also bent by a bending, a bending area may be defined as any point where a bend sensor outputs a resistance value other than that of a circular state.

The sensor 130 may sense a size of a bending line, direction of a bending line, location of a bending line, number of a bending line, count of a bending line, bending speed at which a change of shape occurs, size of a bending area, location of a bending area, and number of bending areas, etc., based on a relationship among the points where the resistance value is sensed.

More specifically, when a distance between the points where a change of resistance value is sensed is within a predetermined distance, the points outputting the resistance value are sensed as one bending area. Meanwhile, if there are points having a distance of or above a predetermined distance of among the points where a change of resistance value is sensed, the points may be defined as another bending area. For detailed explanation, see FIGS. 7 and 8.

FIG. 7 is a view illustrating a method of sensing one bending area. As illustrated in FIG. 7, when the flexible display apparatus 100 is bent, the resistance value from point a1 to a5 of the bend sensors 31-1, point b1 to b5 of bend sensors 31-2, point c1 to c5 of bend sensors 31-3, point d1 to d5 of bend sensors 31-4, and point e1 to e5 of bend sensors 31-5 differ from that of a circular state.

In such a case, the points where a change of resistance is sensed in each bend sensor 31-1 to 31-5 are located within a predetermined distance from each other, and are placed continuously.

Therefore, the sensor 130 senses an area 32 which includes all of point a1 to point a5 in bend sensor 31-1, point b1 to point b5 in bend sensor 31-2, point c1 to point c5 in bend sensor 31-3, point d1 to point d5 in bend sensor 31-4, and point e1 to e5 in bend sensor 31-5 as one bending area.

FIG. 8 is a view illustrating a method of sensing a plurality of bending areas.

In FIG. 8, according to the bending of the flexible display apparatus, point a1 to point a2 and point a4 to point a5 of bend sensor 31-1, point b1 to point b2 and point b4 to point b5 of bend sensor 31-2, point c1 to point c2 and point c4 to point c5 of bend sensor 31-3, point d1 to point d2 and point d4 to point d5 of bend sensor 31-4, and point e1 to point e2 and point e4 to point e5 of bend sensor 31-5 have different resistance value than that of a circle state.

In bend sensor 31-1, each of point a1 to point a2 and point a4 to point a5 is continuous, respectively, but since there exists point a3 between a2 to point a4, point a2 to point a4 is not continuous. Therefore, since a distance from point a2 to point a4 is distanced by a predetermined distance, point a1 to point a2 and point a4 to point a5 may be distinguished as different bending areas from each other. In addition, each point of other bend sensors 31-2 to 31-5 may also be distinguished likewise.

Therefore, the flexible display apparatus 100 may define an area which includes all of point a1 to point a2 in bend sensor 31-1, point b1 to point b2 in bend sensor 31-2, point c1 to point c2 in bend sensor 31-3, point d1 to point d2 in bend sensor 31-4, and point e1 to point e2 in bend sensor 31-5, as one bending area, and define an area which includes all of point a4 to point a5 in bend sensor 31-1, point b4 to point b5 in bend sensor 31-2, point c4 to point c5 in bend sensor 31-3, point d4 to point d5 in bend sensor 31-4, and point e4 to point e5 in bend sensor 31-5 as another bending area.

A bending area may include a bending line. A bending line may be defined as a line which connects the points from which the biggest resistance value in each bending area has been detected.

For example, in the case of FIG. 7, the line 33 connects point a3, which outputs the biggest resistance value in the bending area 33, point b3, which outputs the biggest resistance value in bend sensor 31-2, point c3, which outputs the biggest resistance value in bend sensor 31-3, point d3, which outputs the biggest resistance value in bend sensor 31-4, and point e3 which outputs the biggest resistance value in bend sensor 31-5. Thus, line 33 may be defined as a bending line. FIG. 7 illustrates a state wherein the bending line is formed in a longitudinal direction in a central area of the display surface.

In addition, in the case of FIG. 8, a line 36 which connects point a1, which outputs the biggest resistance value in bending area 34, point b1, which outputs the biggest resistance value in bend sensor 31-2, point c1, which outputs the biggest resistance value in bend sensor 31-3, point d1, which outputs the biggest resistance value in bend sensor 31-4, and point e1, which outputs the biggest resistance value in bend sensor 31-5, may be one bending line. In addition, a line 37 which connects point a5, which outputs the biggest resistance value in bending area 35, point b5, which outputs the biggest resistance value in bend sensor 31-2, point c5, which outputs the biggest resistance value in bend sensor 31-3, point d5, which outputs the biggest resistance value in 31-4, and point e5, which outputs the biggest resistance value in bend sensor 31-5, may be another bending line. That is, FIG. 8 illustrates a state where two bending lines in a longitudinal direction are formed near the left and right edges of the display surface.

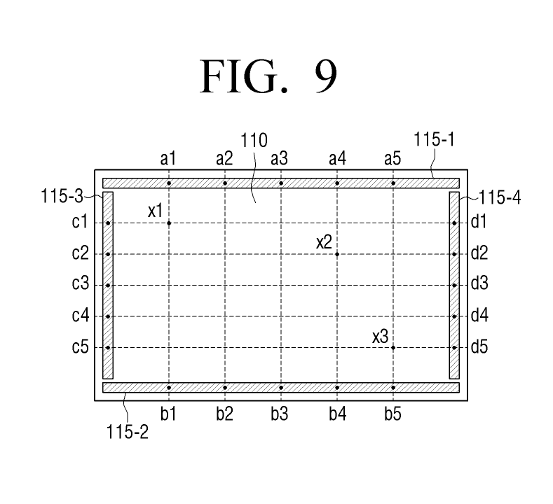

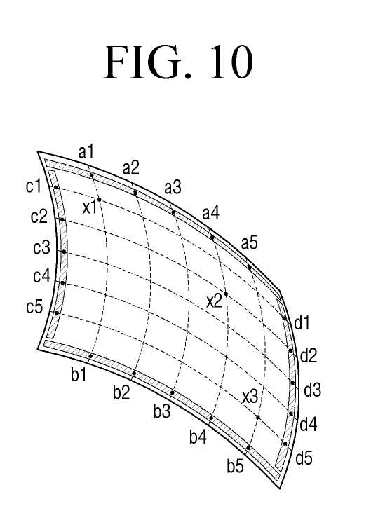

FIGS. 9 and 10 are views illustrating another example of a method of sensing bending using a bend sensor in the flexible display apparatus.

FIG. 9 includes bend sensors 115-1, 115-2, 115-3, and 115-4 in the edges of the displayer 110. When external force is applied to the displayer 110 and a change occurs, external force is also applied to bend sensors 115-1, 115-2, 115-3, and 115-4, causing change, and the resistance value changes according to the degree of that change.

Dotted lines illustrated in FIG. 9 show an area where the bend sensor is placed in FIGS. 3 to 5. In FIG. 9, the resistance values of the bend sensors 115-1, 115-2, 115-3, and 115-4 placed on the edge of the displayer 110 differ according to each bending degree. For example, a first bend sensor 115-1 may sense different resistance values in five points—a1, a2, a3, a4, a5—according to the degree of bending. A second bend sensor 115-2 may sense different resistance values in five points—b1, b2, b3, b4, b5—according to the degree of bending. A third bend sensor may sense different resistance values in five points—c1, c2, c3, c4, c5—according to the degree of bending. A fourth bend sensor 115-4 may sense different resistance values in five points—d1, d2, d3, d4, d5—according to the degree of bending.

The sensor 130 may obtain the resistance value of a longitudinal axis line based on point a1 using the resistance value of a first point a1 of a first bend sensor 115-1 and the resistance value of a third bend sensor 115-3. The resistance value of a longitudinal axis line based on point a2 may be obtained using the resistance value of a second point a2 of the first bend sensor 115-1 and the resistance value of a third bend sensor 115-3. Likewise, the resistance value of a longitudinal axis line based on point a5 may be obtained using the resistance value of a fifth point a5 of a first bend sensor 115-1 and the resistance value of a fourth bend sensor 115-4.

FIG. 10 illustrates a case where a change of shape occurred due to external force applied to the displayer 110. As illustrated in FIG. 10, when a change of shape occurs in the displayer 110, it is possible to sense whether or not the flat panel of the displayer 110 changed using the resistance value sensed in the first bend sensor to the fourth bend sensor, i.e., 115-1, 115-2, 115-3, and 115-4.

For example, the resistance value of point x1 of the displayer 110 is calculated using the resistance value sensed at a first point a1 of the first bend sensor 115-1 and the resistance value sensed at a first point c1 of the third bend sensor 115-3. The resistance value of point x2 is calculated using the resistance value sensed at a fourth point a4 of the first bend sensor 115-1 and the resistance value sensed at a second point d2 of the fourth bend sensor 115-4. The resistance value at point x3 is calculated using the resistance value sensed at a fifth point b5 of a second bend sensor 115-2 and the resistance value sensed at a fifth point d5 of a fourth bend sensor 115-4.

The three points illustrated in FIG. 9 and three points illustrated in FIG. 10 indicate same pixel points in the displayer 110. However, FIG. 9 illustrates a case in which a change of shape has not occurred in the displayer 110, and FIG. 10 illustrates a case in which a change of shape has occurred in the displayer 110.

In the case of FIG. 9, the coordinate values of points x1, x2, x3 may be expressed in a two-dimensional coordinate system. That is, coordinate values of three points may be determined by the coordinate values of the traverse axis (hereinafter referred to as X-axis) and the longitudinal axis (hereinafter referred to as Y-axis).

FIGS. 9 and 10 illustrate the coordinate value mapping relationship regarding three pixels only for convenience of explanation, but the number is not limited, according to the resolution provided in the displayer 110.

Since there is no change of shape of the displayer 110 in FIG. 9, x1 may be expressed in two-dimensional coordinate values, (a1, c1). However, since there is a change of shape of the displayer 110, it is not possible to express the previous two-dimensional coordinate system, but the coordinate value is changed to (a1, c1, z1) according to the third dimensional coordinate system. Herein, the value of z1 can be calculated according to the bending degree and bending direction obtained according to the resistance value of the bend sensor provided in an edge of the displayer 110.

Accordingly, x2 and x3 illustrated in FIG. 10 may be converted into three-dimensional coordinate system from the previous two-dimensional coordinate system, and the Z-axis coordinate value for expressing x2 and x3 may be calculated according to the bending degree and bending direction based on the resistance value sensed by each bend sensor.

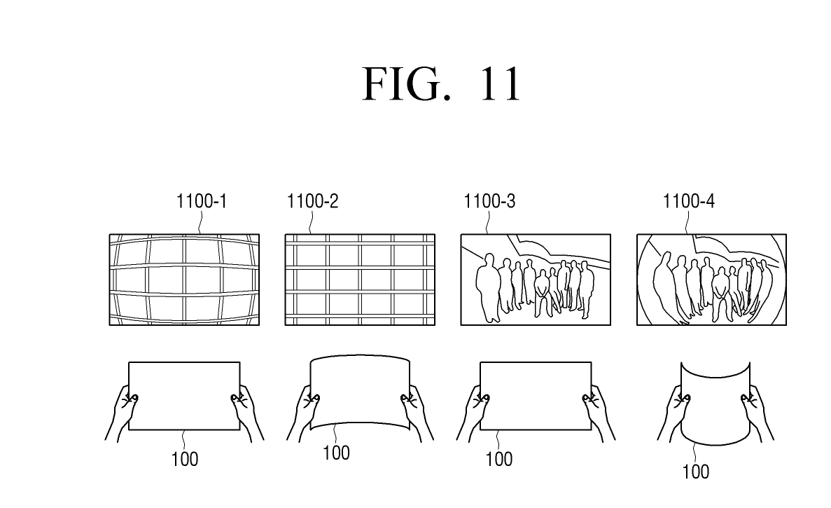

FIG. 11 is a view illustrating an example of a method of editing an image displayed on the flexible display apparatus.

As illustrated in the first from the left view of FIG. 11, an image 1100-1 in which lens distortion has occurred in the flexible display apparatus 100 is displayed.

As illustrated in the second from the left view in FIG. 11, it can be seen that a change of shape of the flexible display apparatus 100 is made to a state in which both edges of the traverse axis of the flexible display apparatus 100 are bent to face the image display direction, and the central axis of the flexible display apparatus 100 is bent to face the opposite direction of the image display direction. As illustrated in the second from the left view in FIG. 11, when a change of shape of the flexible display apparatus 100 is made, a second image 1100-2 where lens distortion has been corrected can be seen.

The controller 140 senses a change of shape of the displayer 110 through the sensor 130, and calculates a three-dimensional coordinate system of the changed displayer 110 based on the sensed change of shape. The controller 140 may correct the lens distortion by matching the coordinate value of the first image 110-1 to the newly calculated three-dimensional coordinate system, and converting it into a second image 1100-2 wherein lens distortion has been corrected.

With reference to the third from the left view in FIG. 11, it can be seen that a third image 1100-3 where lens distortion has been corrected is displayed on the displayer 110 of the flexible display apparatus 100.

With reference to the fourth from the left view in FIG. 11, a change of shape of the flexible display apparatus 100 is made to a state wherein both edges of the traverse axis of the flexible display apparatus 100 are bent to be closer to the edges of the flexible display apparatus 100, and a central axis of the flexible display apparatus 100 is bent to face the image display direction. When such a change of shape of the display apparatus 100 occurs, as illustrated in the fourth left view in FIG. 11, a fourth image 1100-4 having a fisheye effect can be seen.

The controller 140 senses a change of shape of the displayer 110 through the sensor 130, and calculates a three-dimensional coordinate system of the changed displayer 110, based on the sensed change of shape. The controller 140 applies a fisheye effect to the third image 1100-3 by matching the coordinate value of the third image 1100-3 where lens distortion has been corrected to the newly calculated three-dimensional coordinate system, thereby converting it into a fourth image 1100-4 having a fisheye effect.

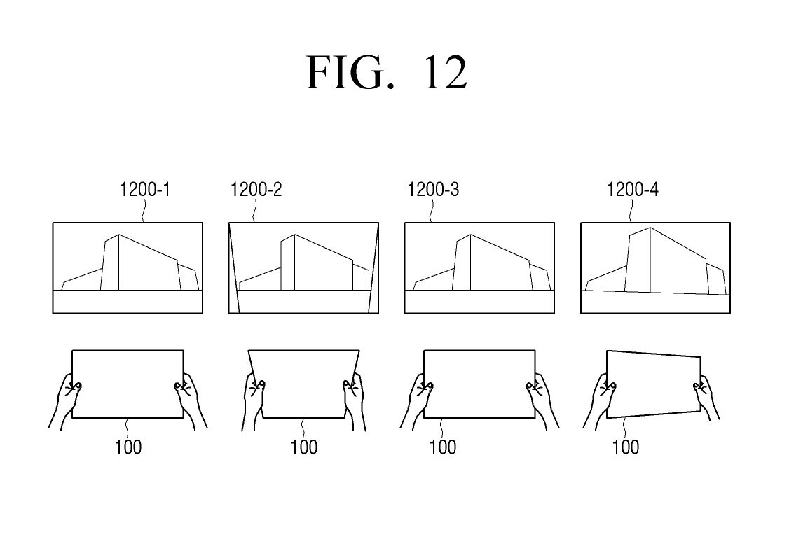

FIG. 12 is a view illustrating another example of a method of editing an image displayed on the flexible display apparatus.

In FIG. 12, the image editing effect caused by tilting the flexible display apparatus 100 to the longitudinal axis or to the traverse axis can be seen.

With reference to the first from the left view in FIG. 12, it can be seen that the first image 1200-1 is displayed on the flexible display apparatus 100.

With reference to the second from the left view of FIG. 12, the flexible display apparatus 100 is tilted such that the upper side in the longitudinal axis direction faces the image display direction, and the lower side faces the opposite direction of the image display direction. In such a state, it is possible to see in the display apparatus 100 a second image 1200-2 wherein an image effect as if one is looking from the top toward the bottom is applied. The controller 140 senses the tilt of the flexible display apparatus 100 through the sensor 130, and changes the coordinate value based on the direction and degree of the sensed tilt to convert the image from the first image 1200-1 into the second image 1200-2.

That is, as illustrated in FIG. 12, in order to exert an image effect of tilting the first image to the longitudinal direction, the sensor 130 of the flexible display apparatus 100 should further include a tilt sensor, a geomagnetic sensor, and an acceleration sensor. Otherwise, the flexible display apparatus 100 should further include a camera and hinge sensor. In the latter embodiment, the controller 140 changes the coordinate value based on the bend angle of the hinge sensor, to convert the first image 1200-1 into the second image 1200-2.

With reference to the third from the left view of FIG. 12, it can be seen that the third image 1200-3 is displayed on the flexible display apparatus 100.

With reference to the fourth from the left view of FIG. 12, the flexible display apparatus 100 is tilted such that the left side in the traverse axis direction faces the image display direction, and the right side faces the opposite direction of the image display direction. In such a state, it is possible to see in the display apparatus 100 a fourth image 1200-4 wherein an image effect as if one is looking at the third image 1200-3 from the left to right in the traverse axis direction is applied.

The controller 140 senses the tilt of the flexible display apparatus 100 through the sensor 130, and changes the coordinate value based on the direction and degree of the sensed tilt to convert the image from the third image 1200-3 into the fourth image 1200-4.

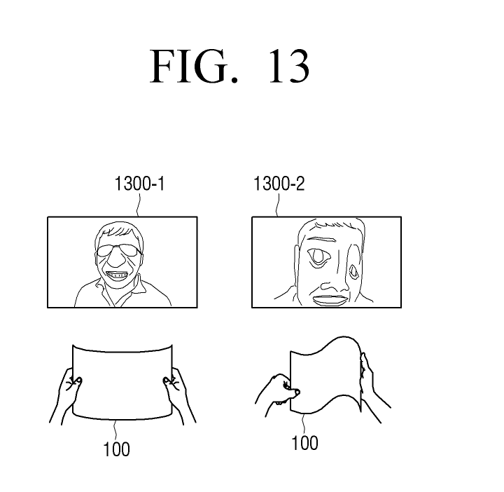

FIG. 13 is a view illustrating another example of a method of editing an image displayed on the flexible display apparatus.

With reference to the left view of FIG. 13, when the central area of the displayer 110 faces the image display direction as the edges of traverse direction of the flexible display apparatus 100 are bent, a change of shape occurs in the central area of the image displayed on the displayer 110. That is, when the flexible display apparatus 100 is bent and an image change is made, the changed image 1300-1 is changed to suit the size of the displayer 110.

With reference to the right view of FIG. 13, by bending the flexible display apparatus 100 in a traverse direction twice, a change occurs both in a first longitudinal area and second longitudinal area of the displayer 110. That is, when an image change is made by bending the flexible display apparatus 100 twice, the changed image 1300-2 is changed to suit the size of the displayer 110 in a state wherein a change has occurred in two longitudinal areas.

In the flexible display apparatus 100 of the present general inventive concept, the user may intuitively change the displayer 110 wherein the image is displayed, thereby visually confirming the effect of the change, and exerting an effect of performing various and geometric image conversions compared to conventional methods of inputting distortion factors.

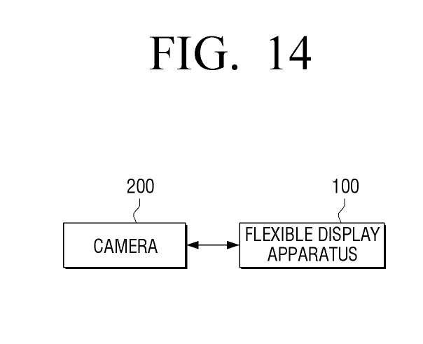

FIG. 14 is a block diagram illustrating a configuration of a camera wherein the flexible display apparatus is mounted according to an exemplary embodiment of the present general inventive concept.

In a state in which a prestored image is displayed, when a change of shape of the flexible display apparatus 100 occurs by a user manipulation, the aforementioned flexible display apparatus 100 may sense a change of shape and change the displayed image.

Such a flexible display apparatus 100 may be connected to the camera 200, and may display the image captured by the camera 200 via live view.

The image displayed on the flexible display apparatus 100 may be image edited in the aforementioned method, and the edited image may be stored in a repository provided in camera 200.

Such a flexible display apparatus 100 may or may not be connected to the camera 200. The flexible display apparatus 100 may receive the image data captured from the camera 200 through the receiver 120, and may receive the image data pre-captured in the camera 200.

The flexible display apparatus 100 according to the present general inventive concept may be an electronic device separate from the camera 200, and may be a configuration separate from the displayer 210 provided in the camera 200.

As such, in the case of mounting the flexible display apparatus 100 according to the present general inventive concept to the camera 200, the user may try various geometric conversions as he/she directly touches the display apparatus 100, exerting an effect of creating unique image conversion effect which may be directed only by the user during photographing the images.

Hereinafter an explanation is provided of an exemplary embodiment of an image capturing apparatus which includes the flexible display apparatus 100 as a portion of the camera 200.

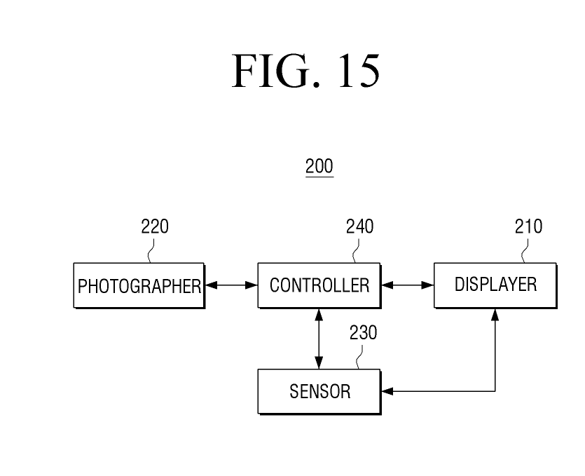

FIG. 15 is a block diagram illustrating a configuration of an image capturing apparatus provided with a flexible display according to another exemplary embodiment of the present general inventive concept.

With reference to FIG. 15, the image capturing apparatus 200 according to the present general inventive concept includes a displayer 210, photographer 220, sensor 230, and controller 240.

The displayer 210, sensor 230, and controller 240 included in the image photographing apparatus 200 according to another exemplary embodiment of the present general inventive concept have similar functions as the displayer 110, sensor 130, and controller 140 of the aforementioned flexible display apparatus 100, and thus specific explanation thereof is omitted.

Hereinafter an explanation is provided of the photographer 220, which is a feature of the image capturing apparatus 200, and of characteristics of using the photographer 220.

The photographer 220 may comprise a lens to collect light of a subject and make an optical image fall into a photographing area, a photographing element to convert light entering through the lens into electric signal, and an AD converter to convert a signal of the photographing element having an analogue format into a digital signal and output the converted signal. The photographing element may be, for example, a CCD (Charge Coupled Device) photographing element or CMOS (Complementary Metal Oxide Semiconductor).

The controller 240 may control the photographer 220 to adjust the focus, contrast, sharpness, and white balance, etc., of the image converted according to the change of shape of the displayer 210.

The controller 240 may analyze the changed shape of the displayer 210 to obtain a three-dimensional coordinate value, and perform a mapping of the obtained three-dimensional coordinate value into a two-dimensional coordinate value to calculate a converted coordinate system.

The image capturing apparatus 200 according to the present general inventive concept may further include a storage unit (not illustrated) which stores images.

When a change of shape of the displayer 210 is sensed, the controller 240 may convert the image displayed on the displayer 210 and store the converted image in the storage unit.

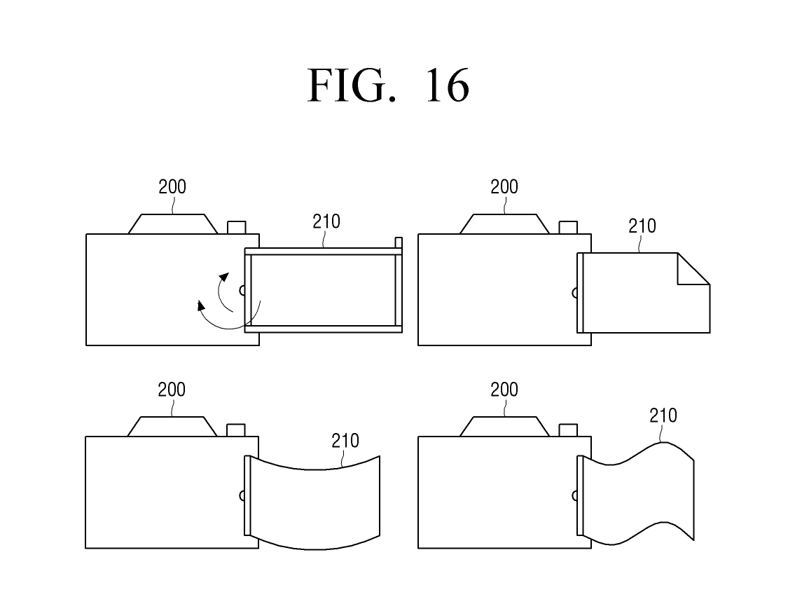

FIG. 16 is a view illustrating various examples of a method of changing the displayer of the image capturing apparatus according to another exemplary embodiment of the present general inventive concept.

With reference to the view on the upper left in FIG. 16, the displayer 210 of the image capturing apparatus 200 according to another exemplary embodiment of the present general inventive concept may display a live view of the photographed image. The displayer 210 may be swiveled and folded such that the surface which displays the image contacts the camera body.

Such a displayer 210 may be made of flexible material, and thus the edge areas may be bent (see upper right view in FIG. 16). Otherwise, the displayer 210 may be bent around the traverse axis (see lower left view in FIG. 16), and the displayer 210 may be bent for twice or more in the traverse axis (see lower right view in FIG. 16).

In FIG. 16, a case where a bending is made in a traverse axis was explained as an example, but the displayer 210 of the image capturing apparatus 200 according to the present general inventive concept may be flexible, and thus a bending around the traverse axis, longitudinal axis, and a combination thereof may be possible, or only an area may be bent.

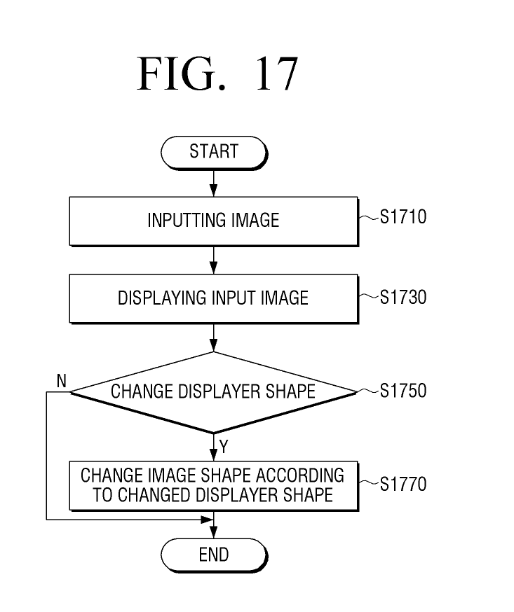

FIG. 17 is a flowchart illustrating an image editing method using a flexible display apparatus according to another exemplary embodiment of the present general inventive concept.

With reference to FIG. 17, the image editing method using the flexible display apparatus according to another exemplary embodiment of the present general inventive concept includes inputting an image to be edited to the flexible display apparatus 100 (operation S1710), displaying the input image on the displayer 110 (operation S1730), sensing whether or not a change of shape has occurred in the displayer 110 (operation S1750), and converting the shape of the displayed image based on the sensed change of shape when a change of shape is sensed in the displayer 110 (operation S1770).

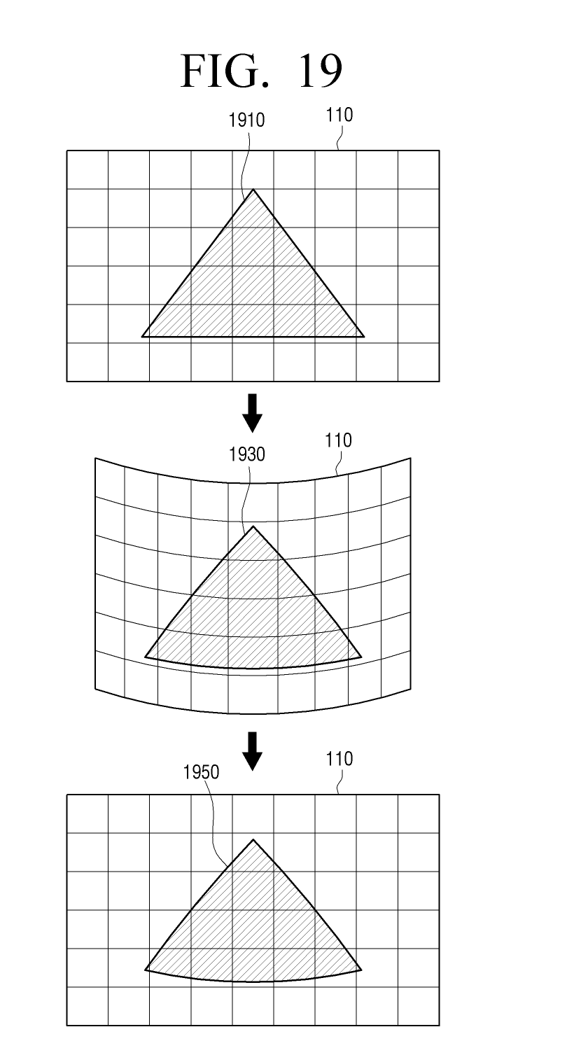

With reference to FIGS. 17 and 19, such a method of editing an image using the flexible display apparatus 100 is as follows:

First of all, image data is inputted to the flexible display apparatus 100. As illustrated in FIG. 19, a triangular image is inputted, and the triangular image 1910 is displayed on the displayer 110.

Displayer 110 is flexible, and thus change of shape may occur by external force. When external force is applied to the displayer 110, and a change of shape occurs, the image displayed on the displayer 110 can also be seen as an image 1930 of a changed shape (see central view in FIG. 19)

The image 1930 shape change is caused by a change of shape of the displayer 110, and thus information on the coordinate system of the changed displayer 110 must be obtained through the sensor 130, and a converted coordinate system must be calculated based on the obtained coordinate system information.

When a shape of image changes due to a change of the displayer 110, in order to store a changed image identical to the image 1930 which can be seen by one's eyes, the coordinate system of the image is transcribed to the converted coordinate system, thereby performing a image conversion.

Consequently, the triangular image 1930 seen as a changed image by one's eyes may be displayed as an image 1950 of the same shape on the flat panel displayer 110 through the flat panel displayer 110, as well as through coordinate system rematching.

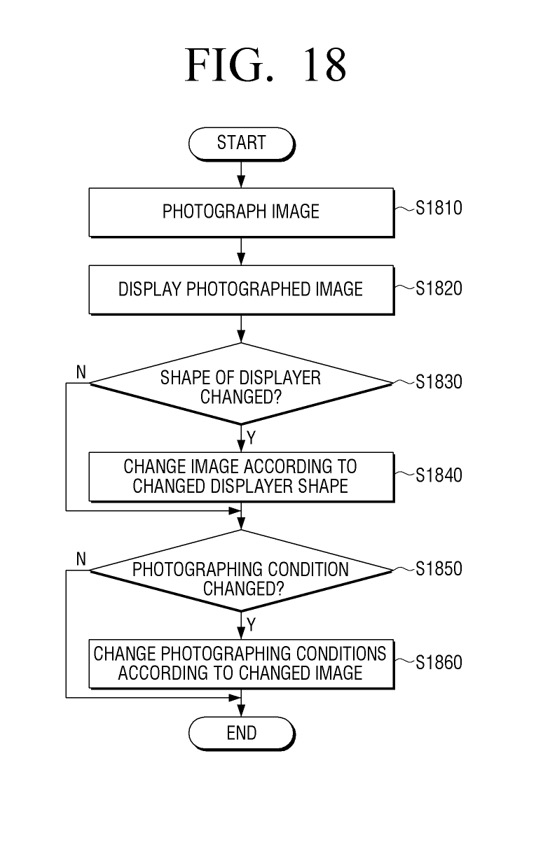

FIG. 18 is a flowchart illustrating the image capturing apparatus provided with a flexible displayer according to another exemplary embodiment of the present general inventive concept.

With reference to FIG. 18, the image editing method of an image capturing apparatus having a flexible displayer according to another exemplary embodiment of the present general inventive concept photographs an image and generates image data (operation S1810), uses the image data of the photographed subject to display the photographed image (operation S1820), and senses whether or not to a change of shape of the displayer occurred during a state wherein the image is displayed (operation S1830). When a change of shape is sensed (operation S1830-Y), a new coordinate system is calculated according to the change of shape of the displayer, and the predisplayed image is matched to the newly calculated coordinate system, thereby converting the image (operation S1840). In a case wherein the image is converted, it is determined whether or not to change the photographing conditions of the converted image (operation S1850). When it is determined to change the photographing condition (operation S1850-Y), photographing conditions are changed according to the converted image (operation S1860). For example, by changing the focus, brightness, sharpness, contrast and white balance of the image, the effect of the converted image is further improved. After the photographing conditions are changed, when the subject is re-photographed under new photographing conditions, the photographed image is converted and then stored in the storage unit.

The image editing method of the flexible display apparatus according to the aforementioned various exemplary embodiments may be embodied as a program and provided to the flexible display apparatus.

As an example, when the steps of inputting the image, displaying the input image, and sensing the change of shape of the displayer are completed, a non-transitory computer readable medium wherein a program of performing the step of converting the image displayed on the displayer according to the change of shape of the displayer is stored may be provided.

A non-transitory computer readable medium refers to a medium where it is possible to store data semi-permanently and where the data is readable by an apparatus. For example, the aforementioned various applications and programs may be stored and provided by means of a non-transitory computer readable medium such as a CD, DVD, hard disk, blu-ray disk, USB, memory card, or ROM, etc.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A flexible display apparatus comprising:
a receiver configured to receive an image;
a displayer of which a changing of shape is possible;
a sensor configured to sense a changing of shape of the displayer; and
a controller configured to convert an image displayed on the displayer according to the changing of shape of the displayer when a changing of shape of the displayer is sensed.

2. The flexible display apparatus according to claim 1,
wherein the controller is further configured to calculate a converted coordinate system by analyzing the changed shape of the displayer, and to convert the image based on the converted coordinate system.

3. The flexible display apparatus according to claim 1,
wherein the controller is further configured to obtain a three-dimensional coordinate system by analyzing the changed shape of the displayer, and to calculate the changed coordinate system by mapping the obtained three-dimensional coordinate value into a two-dimensional coordinate value.

4. The flexible display apparatus according to claim 1,
wherein the flexible display apparatus further comprises a storage unit to store an image, and
the controller is further configured to convert the image displayed on the displayer and store the converted image in the storage unit when a changing of shape of the displayer is sensed.

5. The flexible display apparatus according to claim 1,
wherein a shape of the displayer may be changed by bending or rolling the displayer in an unspecified direction based on a specific point.

6. An image capturing apparatus comprising:
an image photographer to photograph an image;
a displayer which has a changeable physical shape and is configured to display the photographed image;
a sensor configured to sense a changing of shape of the displayer; and
a controller configured to convert the image displayed on the displayer according to the changing of shape of the displayer when a changing of shape of the displayer is sensed.

7. The image capturing apparatus according to claim 6,
wherein the controller is further configured to control the image photographer to control at least one of a focus, contrast, sharpness, and white balance of the image converted according to the changing of shape of the displayer.

8. The image capturing apparatus according to claim 6,
wherein the controller is further configured to calculate a converted coordinate system by analyzing the changed shape of the displayer, and to convert the image based on the converted coordinate system.

9. The image capturing apparatus according to claim 6,
wherein the controller is further configured to obtain a three-dimensional coordinate value by analyzing the changed shape of the displayer, and to calculate the changed coordinate system by mapping the obtained three-dimensional coordinate value into a two-dimensional coordinate value.

10. The image capturing apparatus according to claim 6,
wherein the image capturing apparatus further comprises a storage unit to store an image, and
the controller is further configured to convert the image displayed on the displayer according to the changing of shape of the displayer when a changing of shape of the displayer is sensed, and to store the converted image in the storage unit.

11. The image capturing apparatus according to claim 6,
wherein a shape of the displayer may be changed by bending or rolling the displayer in an unspecified direction based on a specific point.

12. An method of editing an image using a flexible displayer, the method comprising:
receiving an input of an image;
sensing a changing of shape of the displayer; and
converting an image displayed on the displayer according to the changing of shape of the displayer when a changing of shape of the displayer is sensed.

13. The method according to claim 12,
wherein the converting the image comprises calculating a converted coordinate system by analyzing the changed shape of the displayer and converting the image based on the converted coordinate system.

14. The method according to claim 12,
wherein the converting the image further comprises obtaining a three-dimensional coordinate value by analyzing the shape of the displayer; and
calculating the converted coordinate system by mapping the obtained three-dimensional coordinate value into a two-dimensional coordinate value.

15. The method according to claim 12, further comprising:
storing the converted image when a changing of shape of the displayer is sensed.

16. The method according to claim 12,
wherein a shape of the displayer may be changed by bending or rolling the displayer in an unspecified direction based on a specific point.

17. An image editing method of an image capturing apparatus having a flexible displayer, the image editing method comprising:
photographing an image;
displaying the photographed image on the flexible displayer;
sensing a changing of shape of the displayer; and
converting the image according to the changing of shape of the displayer, when a changing of shape of the displayer is sensed.

18. The image editing method according to claim 17,
wherein the image editing method further comprises at least one of adjusting a focus, contrast, sharpness, and white balance of the image converted according to the changing of shape of the displayer.

19. The image editing method according to claim 17,
wherein the converting the image comprises calculating a converted coordinate system by analyzing the changed shape of the displayer; and
converting the image based on the converted coordinate system.

20. The image editing method according to claim 17,
wherein the converting the image further comprises obtaining a three-dimensional coordinate value by analyzing the shape of the displayer; and
calculating the converted coordinate system by mapping the obtained three-dimensional coordinate value into a two-dimensional coordinate value.

21. The image editing method according to claim 17, further comprising:
storing the converted image.

22. The image editing method according to claim 17,
wherein a shape of the displayer may be changed by bending or rolling the displayer in an unspecified direction based on a specific point.

23. A flexible display device, comprising:
a substrate having a structure that can be physically manipulated by a user to change shape;
a display panel mounted on the substrate including a plurality of pixels;
a driver mounted on the substrate configured to provide a driving voltage to the plurality of pixels;
a bend sensor mounted on the substrate to detect when the substrate is bent;
a tilt sensor mounted on the substrate to detect when the substrate is tilted; and
a controller configured to adjust the display of an image on the device based on detections of manipulation from the tilt sensor and one or more bend sensors.

24. The flexible display device of claim 23, wherein the bend sensor comprises a plurality of bend sensors mounted on the surface of the substrate in traverse and longitudinal directions.

25. The flexible display device of claim 23, wherein the bend sensor comprises a plurality of bend sensors mounted on the edges of the substrate.

26. The flexible display device of claim 23, wherein the tilt sensor comprises a geomagnetic sensor and an acceleration sensor.

27. The flexible display device of claim 23, further comprising a protective covering the display panel.

28. The flexible display device of claim 23 wherein the display panel is made of organic luminant and further comprises electrode layers which cover both surfaces of the organic luminant.

29. The flexible display device of claim 28, wherein the driver includes a plurality of transistors corresponding to each pixel of the display device, and the controller is configured to control an electrical signal to a gate of each of the plurality of transistors in order to illuminate the pixels corresponding to the respective transistors.
